(19) United States
(12) Patent Application Publication
(10) Pub. No.: US 2013/0161478 A1
(43) Pub. Date: Jun. 27, 2013

(54) Sensor Carrier and Sensor Module, in Particular for Use in a Local Control Unit for Motor Vehicles

(71) Applicants: Matthias Wieczorek, Neunkirchen am Sand (DE); Helmut Karrer, Fuerth (DE); Andreas Voegerl, Parsberg (DE); Joachim Buhl, Nuernberg (DE); Andreas Albert, Hoechstadt/Aisch (DE); Juergen Henniger, Erlangen-Dechsendorf (DE)

(72) Inventors: Matthias Wieczorek, Neunkirchen am Sand (DE); Helmut Karrer, Fuerth (DE); Andreas Voegerl, Parsberg (DE); Joachim Buhl, Nuernberg (DE); Andreas Albert, Hoechstadt/Aisch (DE); Juergen Henniger, Erlangen-Dechsendorf (DE)

(73) Assignee: CONTI TEMIC MICROELECTRONIC GMBH, Nuernberg (DE)

(21) Appl. No.: 13/807,061

(22) PCT Filed: Jun. 28, 2011
(86) PCT No.: PCT/DE11/01413

§ 371 Date: Mar. 14, 2013

(30) Foreign Application Priority Data
Jun. 29, 2010 (DE) 10 2010 025 591.2

(51) Int. Cl. F16M 13/02

(52) U.S. Cl. CPC F16M 13/02
USPC 248/682

(57) ABSTRACT

The invention discloses a sensor carrier (1), in particular for use in a local control unit of a motor vehicle, comprising a carrier plate (2) for accommodating and positioning at least one sensor (3) and a flexible conductor foil (4) on the carrier plate (2) as an electrical connection between the sensor (3) on the carrier plate (2) and the control unit. A strip-shaped cantilever (5) extends away from the carrier plate (2) such that the sensor (3) that is located at the end of said cantilever (5) will be placed in its intended sensing position when the control unit is installed in a motor vehicle. The carrier plate (2) may comprise more than one strip-shaped cantilever (5) and form a sensor module (6) in this way.

The invention relates to a sensor carrier as well as a sensor module, in particular for use in a local control unit for motor vehicles, according to the preambles of the independent claims.

Such sensor configurations are increasingly used in the automobile industry. The installation site may be a gearbox or the engine compartment of a motor vehicle, for example. The sensor elements are installed directly into control units to determine rotational speed, gear actuator positions, pressure, or other measured variables. They are either integrated into the control unit or attached to the control unit as a sensor module.

The sensors need a mechanical carrier for this purpose that positions and fixates the sensors and is sufficiently stable against vibration. In addition, an electrical connection is needed to forward the sensor signals to the control unit.

A lead frame may be used, for example, as an element for electrically bonding the sensor to the control unit. In a preferred embodiment, the lead frames are encased in a base body, typically by means of a two-step spraying process. Such sensor configurations are called sensor domes. Another design uses flexible conductor foil, which is embedded in plastic sensor domes, as an electrical connection.

The disadvantage of the known sensor configurations is their complex and cost-intensive manufacture. It requires complicated and expensive injection molding tools for intermediate overmolds and the main coating process. In addition, punching and bending tools for lead frames are needed.

It is therefore the object of this invention to provide a sensor carrier and a sensor module, in particular for use in a local control unit of a motor vehicle, that can be produced easier and at lower cost.

This object is achieved, according to the invention, by a sensor carrier and sensor module with the characteristics of independent claims 1 and 10.

The sensor carrier of the invention for a control unit comprises a carrier plate from which in particular a strip-shaped cantilever originates, wherein a sensor is located at the end of said cantilever which is brought into its sensing position by the installation of the control unit into the motor vehicle. This type of sensor carrier is simpler and more cost-effective to produce than a so-called sensor dome that is typically used.

Advantageously, the cantilever comprises at least one section in longitudinal direction, and the sections may form any angle with one another and with the carrier plate. In this way, a sensor at the end of the cantilever can be used even for sensing positions that are difficult to access.

It may be required in some cases to place more than one sensor on one cantilever.

The conductor foil for the electrical connection between the sensor and the control unit is at least partially laminated or glued onto the carrier plate, wherein the conductor foil covers the carrier plate fully or in part only.

A lid is advantageously provided on the cantilever as a chip guard for the contact between sensor and conductor foil. Where the conductor foil is not laminated or glued onto the carrier plate but rests just loosely on the carrier plate, the lid may also be used to fasten the conductor foil to the carrier plate.

In particular, the lid may consist of plastic and be laminated onto the conductor foil, surrounding the cantilever fully or in part only. Alternatively, the lid can be made of aluminum, which also increases its resistance to EMI.

In a particularly simple embodiment, the carrier plate may be a punched sheet. This embodiment has the advantage for the manufacture of the sensor carrier that the cantilever can be bent into position in various spatial directions after the conductor foil has been applied to bring the installed sensor into its intended sensing position. Additional bending of the cantilever or additional structures in the sheet metal can in particular be used to increase the vibration resistance of the sensor carrier.

The carrier plate may in particular comprise more than one strip-shaped cantilever and thus form a compact sensor module.

The description below explains features and details of the invention in depth with reference to embodiments and to the enclosed figures. The figures show the following:

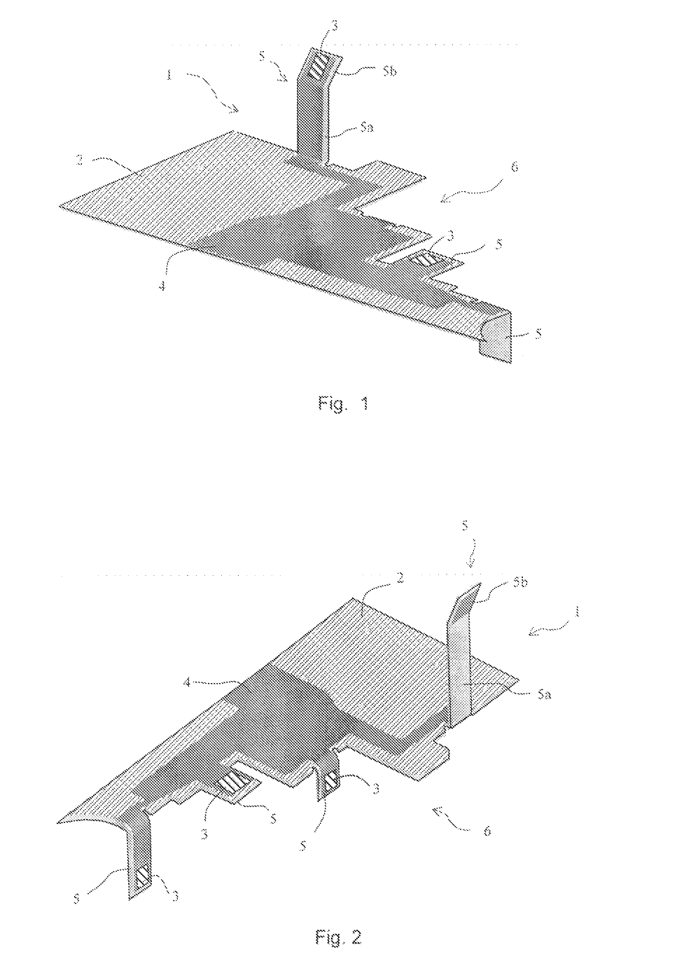

FIG. 1 a perspective view of a sensor carrier with multiple cantilevers, and

FIG. 2 a sensor carrier as shown in FIG. 1, rotated by 180°.

FIG. 1 shows a sensor carrier 1, in particular for use in a local control unit for motor vehicles. The sensor carrier 1 comprises a carrier plate 2 for accommodating and positioning at least one sensor 3. A flexible conductor foil 4 as an electrical connection between the sensor 3 on the carrier plate 2 and the control unit not shown in the figure is provided on the carrier plate 3, especially laminated or glued onto it. The shape of the conductor foil 4 does not match that of the carrier plate 2 in this case, but the carrier plate 2 could also be fully covered by the conductor foil 4.

Strip-shaped cantilevers 5 extend away from the carrier plate 2. The cantilever 5 comprises at least one section 5a, 5b in longitudinal direction, and the sections 5a, 5b may form any angle with one another and with the carrier plate 2. A cantilever 5 and the carrier plate 2 typically form an angle of 0° or 90°. A sensor 3 is located at the end of the cantilever 5. When installed into a motor vehicle, the sensor will then advantageously be located in its intended sensing position.

The flexible conductor foil 4 is conducted from the carrier plate 2 to the cantilever 5 and serves as electrical connection between the sensor 3 and a control unit not shown in the figure. More than one sensor 3 may be provided on a cantilever 5. Furthermore, other electronic components in addition to sensors 3 may be located on the cantilever 5.

The carrier plate 2 may in particular be made of plastic or metal. In a particularly simple embodiment, the carrier plate 2 may be a punched sheet. This embodiment has the advantage for the manufacture of the sensor carrier 1 that the cantilever 5 can be bent into position, section by section, in various spatial directions after the conductor foil 4 has been applied to bring the sensor 3 installed on it even into a sensing position that is difficult to reach. When using a punched and bent sheet metal part, the process steps for producing the sensor module 1 just include bending the punched sheet and laminating the conductor foil 4 onto the same. No complicated and expensive injection molding tools for intermediate overmolds and the main coating process like for producing sensor domes are needed. Furthermore, no punching and bending tools for lead frames that are used in sensor domes as electrical connection between the sensor and the control unit are required.

The sensor module 6 may be integrated into the control unit or attached to it by means of frictional or form-fit connections.

This invention was presented in the above description with the intention to explain the principle of the invention and its practical application as best as possible. But the invention can, of course, be implemented in numerous other embodiments if suitably modified.

1. A sensor carrier, for use in a local control unit of a motor vehicle, comprising a carrier plate for accommodating and positioning at least one sensor and a flexible conductor foil on the carrier plate as an electrical connection between the sensor on the carrier plate and the control unit, characterized in that a strip-shaped cantilever extends away from the carrier plate such that the sensor that is located at the end of said cantilever will be placed in its intended sensing position when the control unit is installed in a motor vehicle.

2. The sensor carrier according to claim 1, characterized in that the cantilever comprises at least one section in longitudinal direction, and that the sections may form any angle with one another and with the carrier plate.

3. The sensor carrier according to claim 1, characterized in that more than one sensor is located on one of the cantilevers.

4. The sensor carrier according to claim 1, characterized in that the conductor foil is at least partially laminated or glued onto the carrier plate.

5. The sensor carrier according to claim 1, characterized in that the conductor foil covers the carrier plate fully or in part only.

6. The sensor carrier according to claim 1, characterized in that a lid is located on the cantilever, wherein the lid serves as a chip guard for the contacting between the sensor and the conductor foil or for fastening the conductor foil on the carrier plate, respectively.

7. The sensor carrier according to claim 6, characterized in that the lid is laminated onto the conductor foil.

8. The sensor carrier according to claim 1, characterized in that the carrier plate is a punched sheet.

9. The sensor carrier according to claim 1, characterized in that the cantilever comprises structures that increase its vibration resistance.

10. A sensor module for use in a local control unit of a motor vehicle, with a sensor carrier according to claim 1, wherein the carrier plate comprises more than one strip-shaped cantilever.
